(19) United States
(12) Patent Application Publication
(10) Pub. No.: US 2026/0222616 A1
(43) Pub. Date: Jul. 30, 2026

(54) SYSTEMS AND METHODS FOR FRAME AND REGION TRANSFORMATIONS WITH SUPERRESOLUTION

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US); Ashan Perera, Boca Raton, FL (US)

(73) Assignee: OP Solutions LLC, Amherst, MA (US)

(21) Appl. No.: 19/121,914

(22) PCT Filed: Oct. 6, 2023
(86) PCT No.: PCT/US2023/034638

§ 371 Date: Apr. 17, 2025

Related U.S. Application Data
(60) Provisional application No. 63/413,814, filed on Oct. 6, 2022.

(51) Int. Cl. H04N 19/59; H04N 19/132; H04N 19/167; H04N 21/2343

(52) U.S. Cl. CPC H04N 19/59; H04N 19/132; H04N 19/167; H04N 21/234363

(57) ABSTRACT

Systems and methods for encoding and decoding video for machine consumption in which superresolution is used to upsample regions of interest at a decoder are provided. A decoder receives an encoded bitstream that has at least one packed frame with at least one region of interest therein being downsampled prior to encoding. A superresolution processor selectively performs upsampling of the identified regions. Parameters related to downsampling may be signaled in the bitstream and used to identify regions of interest to upsample. The superresolution processor may include a neural network trained on a dataset of images that have similar statistical properties to the pictures that are anticipated by a machine system receiving the decoded bitstream and may be trained based on a loss function in a task network based on that dataset.

### CROSS-REFERENCE TO RELATED APPLICATIONS

The present application claims the benefit of priority to U.S. Provisional Application Ser. No. 63/413,814 filed on Oct. 6, 2022, and entitled “Systems and Methods for Frame and Region Transformations with Superresolution,” the disclosure of which is hereby incorporated by reference in its entirety.

### FIELD OF THE DISCLOSURE

The present disclosure generally relates to the field of video encoding and decoding and in particular, the present disclosure is directed to coding of video and other data for machine consumption.

### BACKGROUND OF THE DISCLOSURE

Recent trends in robotics, surveillance, monitoring, Internet of Things, etc. introduced use cases in which a significant portion of all the images and videos that are recorded in the field is consumed by machines only, without ever reaching human eyes. Those machines process images and videos with the goal of completing tasks such as object detection, object tracking, segmentation, event detection etc. Recognizing that this trend is prevalent and will only accelerate in the future, international standardization bodies established efforts to standardize image and video coding that is primarily optimized for machine consumption. For example, standards like JPEG AI and Video Coding for Machines are initiated in addition to already established standards such as Compact Descriptors for Visual Search, and Compact Descriptors for Video Analytics. Solutions that improve efficiency compared to the classical image and video coding techniques are needed. One such solution is presented here.

### SUMMARY OF THE DISCLOSURE

In one embodiment, a decoder is provided for decoding an encoded bitstream that has at least one packed frame of regions of interest with at least one region of interest being downsampled prior to encoding. The decoder includes a video decoder which receives the encoded bitstream and decompreses the bitstream to extract and identify regions of interest and region parameters therefrom. A superresolution processing and region unpacking module is provided which identifies decompressed regions of interest that were downsampled prior to encoding and that are to be upsampled using superresolution. A superresolution network is used to perform upsampling of the identified regions. After upsampling, the decoded regions of interest and upsampled regions of interest are arranged in a reconstructed frame with size, position and orientation of each region corresponding to the original frame.

In some embodiments, parameters related to regions downsampled prior to encoding are signaled in the bitstream and the superresolution processing and region unpacking module use the parameters from the bitstream to identify regions of interest to upsample. In some examples, the parameters include an indicator of one of a plurality of region types and the superresolution network applies upsampling in a manner specific to the indicated region type.

In some embodiments, the superresolution processing and region unpacking module incudes a superrsolution network comprising a trained neural network. The superresolution network may be trained on a dataset of images that have similar statistical properties to the pictures that are anticipated by a machine system receiving the decoded bitstream. In some cases, the superresolution network is trained to optimize object detection in the pictures anticipated by the machine system. The superresolution network may be trained based on a loss function in a task network.

In another embodiment, an encoder is provided for compressing and encoding video for machine consumption. The encoder may include a region detector module receiving the source video and identifying regions of interest therein, the regions of interest being defined in part by coordinates of a bounding box in the frame of source video. A region transform module performs downsampling on at least one region of interest, where the downsampling is preferably based at least in part on transform parameters from a machine system coupled to a decoder with a superresolution network for upsampling. The encoder further includes a region packing module which receives the set of regions of interest and transformed regions of interest and arranges the regions of interest into a packed frame in which pixels outside the regions of interest are substantially excluded. A video encoder receives the packed frame and coordinates of the regions of interest and encodes the packed frame and region parameters into a coded bitstream.

In some embodiments, the regions of interest comprise a plurality of object types and the transform properties are preferably specific to an object type. In some embodiments, the transform properties are based at least in part on a superresolution network in a decoder which is trained by a task network to optimize a loss function. The superresolution network may be trained on a dataset of images that have similar statistical properties to the pictures that are anticipated by a machine system.

In some embodiments, downsampling may be determined on a region-by-region basis. Downsampling may be characterized by downsampling parameters that are applied by the region transform module for a region of interest and, preferably, the downsampling parameters for each downsampled region of interest are signaled in the coded bitstream.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE FIGURES

FIG. 1 is a simplified block diagram of a system for encoding and decoding video for machines, such as in a system for Video Coding for Machines (VCM).

FIG. 2 is a simplified block diagram of a system for encoding and decoding video for machines, such as Video Coding for Machines (“VCM”), with region packing in accordance with the present methods.

FIG. 3 is a simplified block diagram of a training loop for a superresolution network in accordance with the present disclosure.

FIGS. 4A-4D are an example of pictures illustrating the impact of superresolution, where FIG. 4A is an original picture, FIG. 4B is a downsampled picture, FIG. 4C is an upsampled picture using conventional interpolation, and FIG. 4D is an upsampled picture using superresolution in accordance with the present disclosure.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DESCRIPTION OF EMBODIMENTS

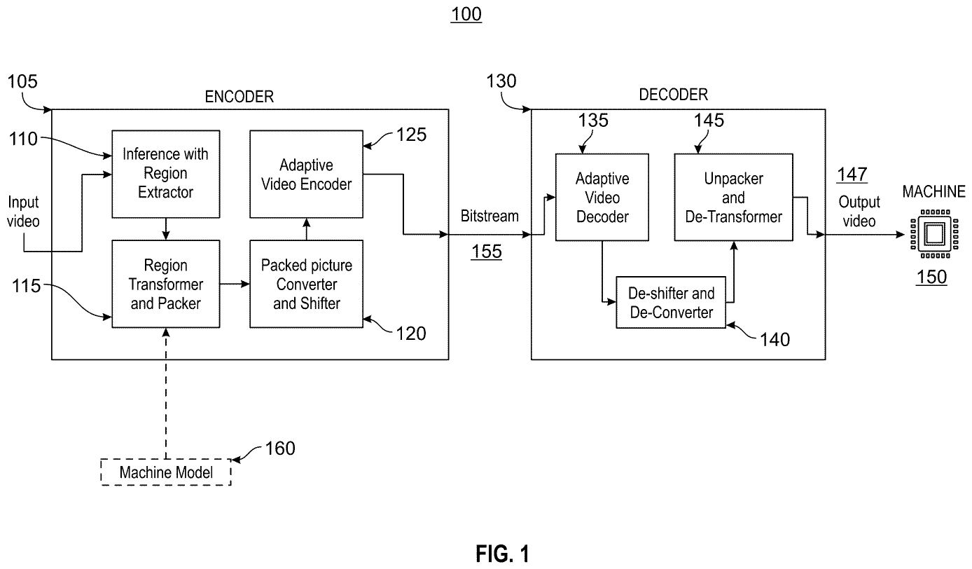

FIG. 1 is a block diagram illustrating an exemplary embodiment of a system comprising of an encoder, a decoder, and a bitstream well suitable for machine-based consumption of video, such as contemplated in applications for Video Coding for Machines (“VCM”). While FIG. 1 has been simplified to depict the components used in coding for machine consumption, it will be appreciated that the present systems and methods are applicable to hybrid systems which also encode, transmit and decode video for human consumption as well. Such systems for encoding/decoding video for various protocols, such as HEVC, VVC, AV1 and the like as are generally known in the art.

Referring now to FIG. 1, an exemplary embodiment of a coding system 100 comprising an encoder 105 which generates an encoded bitstream 155 that is transmitted over a communication channel to a decoder 130 is illustrated.

Further referring to FIG. 1, encoder 105 may be implemented using any circuitry including without limitation digital and/or analog circuitry or a processor programmed to perform the various functions. Encoder 105 may be configured using hardware configuration, software configuration, firmware configuration, and/or any combination thereof. Encoder 105 may be implemented as a computing device and/or as a component of a computing device, which may include without limitation any computing device as described below.

Encoder 105 may include, without limitation, an inference with region extractor module 110, a region transformer and packer module 115, a packed picture converter and shifter module 120, and/or an adaptive video encoder module 125.

Further referring to FIG. 1, adaptive video encoder 125 may be a standard encoder for generating a bitstream compliant with known CODEC standards such as HEVC, AV1, VVC and the like, and may include, without limitation, any video encoder as described in further detail below.

Still referring to FIG. 1, an exemplary embodiment of decoder 130 is illustrated. Decoder 130 may be implemented using any circuitry including without limitation digital and/or analog circuitry. Decoder 130 may be configured using hardware configuration, software configuration, firmware configuration, and/or any combination thereof. Decoder 130 may be implemented as a computing device and/or as a component of a computing device, which may include without limitation any computing device as described below. In an embodiment, decoder 130 may be configured to receive an encoded bitstream 155 and generate an output video 147 suitable for machine consumption and/or a video for human consumption in a hybrid system. Reception of a bitstream 155 may be accomplished in any manner described below. A bitstream may include, without limitation, any bitstream as described below. The present systems and methods are not limited to a particular CODEC standard and are applicable to current standards such as AV1, HEVC, VVC and the like and variants and improvements thereto. It will be appreciated that the specific structure and operation of the encoder 105 and decoder 130 will depend, in part, on the specific encoding standard used in the deployed system and such encoders and decoders are generally known in the art.

With continued reference to FIG. 1, a machine model 160 may be present in the encoder 105, or otherwise provided to the encoder 105 in an online or offline mode using an available communication channel. Machine model 160 is application/task specific and generally contains information sufficient to describe requirements for task completion by machine 150. Machine 150 may provide periodic updates to the machine model 160 based on system updates or data related to processing performance. This information can be used by the encoder 105, and in some embodiments specifically by the region transformer and packer module 115.

Given a frame of a video or an image, effective compression of such media for machine consumption often can be achieved by detecting and extracting its important regions and packing them into a single frame. Simultaneously, the system may discard any detected objects or regions that are not of interest. These packed frames serve as input to a video encoder to produce a compressed bitstream. The compressed bitstream contains the encoded packed regions along with parameters needed to reconstruct and reposition each region in the decoded frame. A machine task system 150 can perform designated functions, such as computer vision related functions, on the reconstructed video frames.

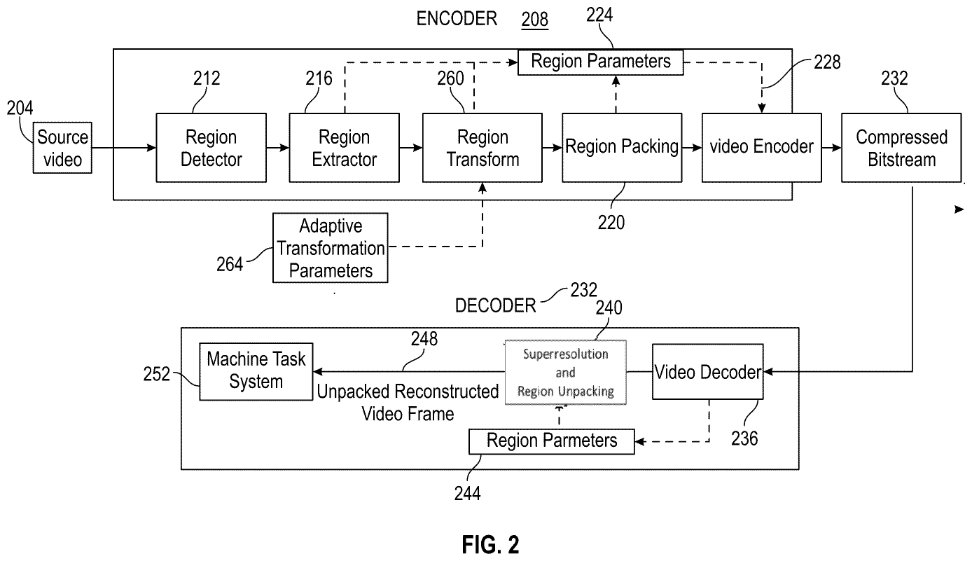

Such a video compression system can be improved by applying region transformations after the regions of interest are identified by module 110. Incorporation of a region transformer and packer module 115 is used to adaptively apply manipulate the extracted objects or regions of interest, typically defined by bounding boxes, in order to create optimal regions for packing and encoding. Applied transformations aim to reduce encoded frame bits while simultaneously maintaining or improving endpoint machine task performance. FIG. 2 shows the proposed video compression system 200, comprised of the 208 encoder side modules and 236 decoder side modules.

FIG. 2 is a simplified block diagram of a system for encoding and decoding video for machines with region packing in accordance with the present disclosure. The system is generally comprised of an encoder 208 and a decoder 232. The encoder 208 includes a region detection block 212, region extractor block 216, a region transform block 260, a region packing block 220, region parameters 224, and a video encoder 228 which are cooperatively interconnected to generate a compressed bitstream 232. The region transform block 260 is interposed between region extractor 216 and region packing block 220 and receives adaptive transform parameters 264 and also provides signals to region parameter block 224.

The decoder 236 includes a video decoder 236 which receives the compressed bitstream 232, a superresolution and region unpacking module 240 coupled to region parameters 243 which generates unpacked reconstructed video frames 248 for the machine task system 252.

As used herein the terms block and module are generally used interchangeably and refer to circuitry, hardware, software, firmware, and combinations thereof, which operate to perform the described features and functions. The term module or block represents functionality and not necessarily a physical distribution or division of the device. It will be appreciated that such functionality may be combined or divided into submodules without departing from the present disclosure.

Referring to FIG. 2 and the encoder 208, significant frame or image regions in the source video 204 are identified using the encoder side region detector module 212, which produces coordinates of discovered objects. The coordinates may define a rectangular bounding box although other bounding geometries are possible.

Saliency based detection methods using video motion may also be employed to identify important regions. For example, uniform motion that is detected across consecutive frames can be designated as salient. In another example, any motion that persists over long periods of time (for example 100 frames) in a continuous trajectory can be designated as salient. In another example, motion that is detected at the same coordinates at which the objects are detected can be designated as salient. Spatial coordinates of salient regions are used to determine regions for packing and enable the identification of pixels deemed as unimportant to the detection module. Such unimportant regions may be discarded and are not used in packing.

The region extractor module 216 extracts the image regions identified by region extractor 212 and prepares the coordinates to be used through the rest of the pipeline. It will be appreciated that coordinates for extracted regions may be provided in any number of formats to specify the region. For rectangular regions, for example, a single corner can be specified along with length and width parameters of the region or two diagonal opposing corner coordinates may be specified, and the like.

The region transform module 260 receives object coordinates from region extraction module 216. The proposed transformation module may adaptively apply transformations such as scaling, rotation, and/or translation on a per-region basis. Internal decisions made within the module may use confidence-based, class-based, area-based, or coding unit-based methods to apply these actions.

Transformations are generally applied with the goal of reducing the bitrate budget needed to encode the frames containing transformed regions. In some cases, transformations can be applied for the benefit of improved detection accuracy on the machine. In one embodiment, the region transformation module implements a downsampling algorithm which can reduce spatial and/or temporal resolution of the extracted regions or whole input frames/pictures. One example is downscaling of the resolution by a certain factor in either or both of a horizontal and a vertical direction. Another example is reduction of the framerate for the input video by discarding frames at predetermined intervals. Since the operation of downsampling is implemented on the encoder, the reciprocal upsampling needs to be performed on the decoder in order to recover the original size of the picture or region of the picture that is used by the task algorithm. By downsampling the image before compressing it in the bitstream, a significant savings in necessary for bitstream representation are achieved. However, in order to maintain accuracy of the task algorithm, the spatial and temporal resolutions of the pictures need to be recovered. This is typically done at the decoder side by the technique of upsampling. Upsampling can be implemented using inverse of downsampling, with interpolation. However, in some cases results achieved with the classical techniques are not satisfactory, since interpolation process introduces levels of noise that cannot be handled by the task algorithm.

A better alternative is superresolution, which is described for example in an article by Chaudhuri, S. (Ed.), (2001), Super-resolution imaging (Vol. 632). Springer Science & Business Media, which is incorporated herein by reference in its entirety. In general, superresolution is a process for generating a high resolution representation of a low resolution image or video frame. The present disclosure implements a superresolution process preferably using a pre-trained convolutional neural network. This type of superresolution is capable of reconstructing pixels that are altered or lost during the downsampling process by learning the statistics of natural images. Preferably, a superresolution network may be trained on the dataset of images that have similar statistical properties to the pictures that are anticipated by the encoder in the real use case. Also, for best results, the same downsampling algorithm that is used by the encoder is implemented in the superresolution network training. Further details on the superresolution network training are described later in the disclosure.

A class-based technique may consider the categories of objects which quickly drop in machine task performance metrics when scaling is applied. That is, of the classes present in a video frame, the superresolution and region unpacking module 240 shall consider which of the objects can be scaled and by how much. Input parameters 264 can be used to indicate the classes of objects that may be scaled along with the classes of objects that should be preserved in size. Detected objects from 212 within the extracted regions can be used to identify which classes are present in each of the regions.

Aforementioned transform parameters 264 may be determined by examining machine task performance across different scaling factors on a per class basis. This can be done by taking a video or image sample similar to (or from) the type of data seen at source video 204 and evaluating its behavior at different scales. Additionally, transform parameters may include per-class scaling parameters 264 which may be determined by analyzing the data in which endpoint machine task system 252 is trained on. That is, it may be beneficial to identify the characteristics of objects in the training dataset. For example, a machine task system trained on a dataset with small objects may enable more aggressive scaling from the region transform module.

Area-based scaling offers an alternative solution to determining scaling factors for region boxes. In a class unaware scenario, the relative sizes of the extracted regions (and/or the sizes of the objects present within in region) may be used to perform scaling. For example, boxes which contain relatively large objects may be scaled more than regions with smaller objects.

Coding Tree Unit (CTU) aware methods may be employed to apply scaling in such a way that each frame may be encoded more efficiently. Scaling each of the region boxes to better align to coding tree units may serve to reduce the frame size while also optimizing the packed frame for encoding.

Rotation transformations may be applied in order to create optimal boxes for packing. This action may be performed on a per-region basis-based on characteristics of the frame and the objects present. That is, boxes may be rotated in order to create better packed frames that can be encoded more efficiently.

Such region transformations aim to reduce the bits in the 232 compressed bitstream while also ensuring that 252 machine task system performance is improved or maintained. The class-based techniques can significantly reduce the bits per pixel while maintaining machine task performance level.

The transformed region box coordinates, returned from the transformation module 260, serve as input to the region packing system 220. The region packing module 220 extracts the significant image regions, as transformed by region transform module 260, and packs them tightly into a single frame. The region packing 220 module produces packing parameters that will preferably be signaled later in bitstream 232.

Packed object frames which contain the transformed regions from 260 are processed through video encoder 228 to produce a compressed bitstream 232. The compressed bitstream includes the encoded packed regions along with parameters 224 needed to reconstruct and reposition each region in the decoded frame. Original region sizes (i.e., those derived from inference 212, prior to region transform 260) are preferably signaled in bitstream 232 for decoder side usage, and for usage by the superresolution network, described later in the disclosure.

The compressed bitstream 232 is decoded using video decoder 236 to produce a packed region frame along with its signaled region information. Such region information includes parameters needed for reconstruction of the frame. This preferably includes any transformation information signaled from the region transform module 260.

### Superresolution and Region Unpacking

The decoded region parameters are used to unpack the region frames via superresolution and region unpacking module 240. Each box is returned to its position within the context of the original video frame. The resulting unpacked frame only includes the significant regions determined by region detection system 212 and does not include the discarded regions or pixels thereof. Transformations performed by the region transform module 260 at the encoder are also undone in the unpacking stage. That is, each box is returned to its original size and orientation before being placed in the unpacked frame. The downsampled frames or boxes are upsampled through the superresolution network, which takes as input the box or a frame and outputs upsampled box or a frame. The details of the superresolution network are presented later in the disclosure.

### Signaling Superresolution in Bitstream

The decision to downsample a picture or a region of a picture is made by the encoder 208 based on the stored information pertaining to the characteristics of the picture or the regions of the picture. Examples of the stored information that can be used to decide to spatially downsample are relative size of the detected objects, texture and color information, class identification of the detected objects, and for temporal downsampling, a framerate of the input source video 204. For example, a picture of a car that occupies most of the picture can be downscaled to the size that is determined to match the size of the average car sample used to train the task network. In this example, relative size and the class identity of the object may be used. In other examples one or more criteria or a combination of multiple criteria can be used.

Encoder 208 may implement downsampling in the region transform module 260. For each picture and region of picture that is downsampled, the encoder 208 preferably signals to the decoder that upsampling, preferably by superresolution, should be applied.

Application of superresolution can be signaled to adaptively enable superresolution in certain videos of frames.

| | Descriptor |
|---|---|
| picture_level_information ( ) { | |
| . . . | |
| . . . | |
| is_super_resolution_used | u(1) |
| if (is_super_resolution_used){ | |
| is_super_resolution_used_for_entire_picture | u(1) |
| default_super_resolution_model_id | u(16) |
| default_super_resolution model_name_length | u(8) |
| default_super_resolution model_name | u(8)* |
| [default_super_resolution model_name_length] | default_ |
| | super |
| | resolution |
| | model |
| | name_ |
| | length |
| } | |
| . . . | |
| } | |

| | Descriptor |
|---|---|
| Region_description_information ( ) { | |
| . . . | |
| is_super_resolution_used | u(1) |
| if (is_super_resolution_used){ | |
| is_region_specific_super_resolution_model_used | u(1) |
| if (is_region_specific_super_resolution_model_used){ | |
| region_specific_super_resolution_model_id | u(16) |
| region_specific_super_resolution model_name_length | u(8) |
| region_specific_super_resolution model_name | u(8)* |
| [region_super_resolution model_name_length] | region_ |
| | specific_ |
| | super |
| | resolution |
| | model |
| | name_ |
| | length |
| } | |
| } | |
| . . . | |
| } | |

Use of super resolution can be signaled for the entire picture or regions of the picture. Picture level information can be encoded in higher level headers such as picture parameter sets or slice headers. A picture may have multiple regions and each region may use a different super resolution method. Some regions may not use any superresolution method and may rely on default upscaling methods.

When the superresolution methods are used for the entire video sequence or a group of frames, the super resolution method details can be signaled in sequence header or a group of frame header.

is_super_resolution_used—signals if super resolution methods are used in this picture
is_super_resolution_used_for_entire_picture—signals if super resolution is applied o the entire picture instead of the regions. The coded region is scaled to the display or output resolution using superresolution methods.
default_super_resolution_model_id—identifier for the superresolution model to be used. A list of available models is available at the decoder
default_super_resolution model_name_length—number of byes of the super resolution model name. if set 0, the model name is not specified.
default_super_resolution model_name—name of the super resolution model is an alternative to the super resolution model id. When model ID is set to 0, model is identified by name.

Region specific super resolution models can be specified. The regions may use the default super resolution method or a model specific to this region. Such information is signaled in the region description information.

is_region_specific_super_resolution_model_used—if set to 1, signals the use of superresolution methods that are different from the default method signaled in the picture level information. When set to 0 the default method signaled in the picture level is used.

region_specific_super_resolution_model_id—identifier for the super resolution model id specific for this region

region_specific_super_resolution model_name_length—number of byes of the super resolution model name. if set 0, the model name is not specified.

region_specific_super_resolution model_name—name of the super resolution model is an alternative to the super resolution model id. When model ID is set to 0, model is identified by name. The unpacked and reconstructed video frame 228 is used as input to machine task system 252 which may perform computer vision related functions. Machine task performance on the regions determined by the detection module 212 may be analyzed to determine optimal transformation parameters. Optimized region transformation parameters 264 may be updated and signaled to the pipeline in order to effectively apply transformations to the encoder-side region boxes.

### Superresolution Network and Training

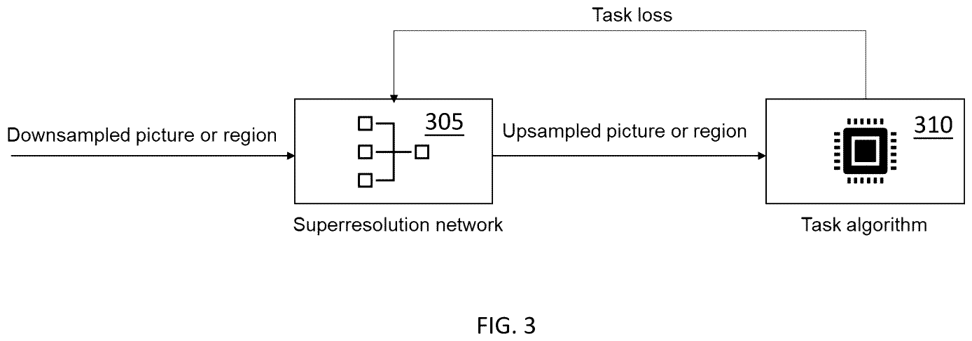

Superresolution network can be implemented using any network architecture that allows picture input and output, and is trainable. Examples include Convolutional Neural Networks, Residual Neural Networks, Long Short-Term Memory Networks, Transformer Networks, and any combination of the aforementioned networks. The method for training such network is presented here and is further depicted in FIG. 3.

Referring to FIG. 3, the supperresolution network is connected to the task algorithm 310, such as detection or segmentation convolutional neural network. Output of the supperresolution network 305, the upsampled picture or a box is fed to the task network, which indicates the successful or unsuccessful detection/segmentation and the calculated loss (for example, Mean Average Precision) is sent back to the superresolution network 305, which uses calculated loss to adjust the weights of the network using backpropagation. Superresolution network 305 can combine calculated task loss with other loss functions ordinarily used for superresolution, such as Mean Average Error, Peak Signal to Noise Ratio, Structural Similarity Index, or other perceptual measures. After achieving a desired level of task loss reduction, trained network is frozen and sent to the decoder to be used in the superresolution and region unpacking module 240. Superresolution weights can be regularly updated to accommodate different use cases and tasks.

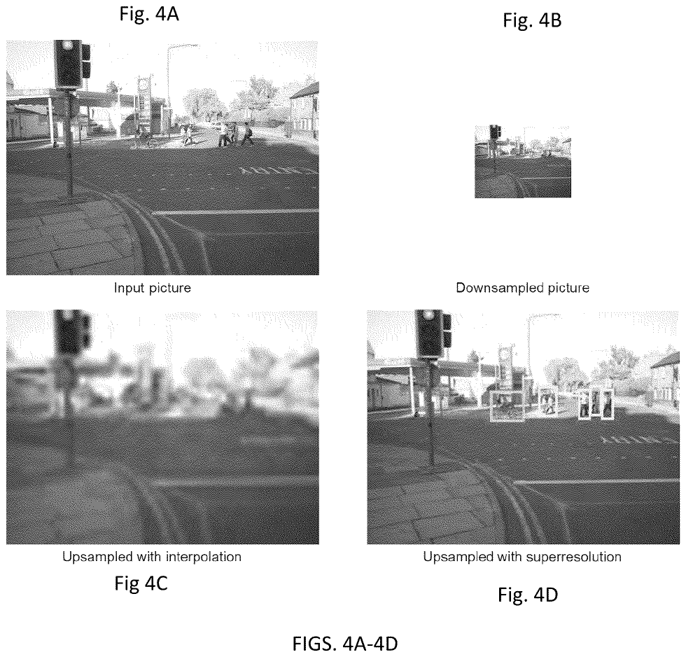

An example of the benefits of using superresolution over the classical upsampling methods is depicted in FIGS. 4A-4D. FIG. 4A is an example of an input picture and FIG. 4B is the picture of FIG. 4A after downsampling. When upsampled with classical methods using interpolation as shown in FIG. 4C, task network cannot recognize any objects. When upsampled using the present superresolution method, as illustrated in FIG. 4D, the task network properly detects several objects including pedestrians and a bicycle with rider.

Some embodiments may include non-transitory computer program products (i.e., physically embodied computer program products) that store instructions, which when executed by one or more data processors of one or more computing systems, cause at least one data processor to perform operations herein.

Embodiments may include circuitry configured to implement any operations as described above in any embodiment, in any order and with any degree of repetition. For instance, modules, such as encoder or decoder, may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder or decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder and/or encoder may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

What is claimed is:

1. A decoder for decoding an encoded bitstream having a packed frame of regions of interest, at least one region of interest being downsampled prior to encoding, the decoder comprising:
a video decoder, the video decoder receiving the encoded bitstream and decompressing the bitstream to identify regions of interest and region parameters therefrom;
a superresolution processing and region unpacking module, the superresolution processing and region unpacking module:
identifying decompressed regions of interest that were downsampled prior to encoding and to be upsampled using superresolution;
applying said downsampled regions to a superresolution network to perform upsampling; and
arranging the decoded regions of interest and upsampled regions of interest in a reconstructed frame with size, position and orientation corresponding to the original frame.

2. The decoder of claim 1, wherein parameters related to regions downsampled prior to encoding are signaled in the bitstream and the superresolution processing and region unpacking module use said parameters to identify regions of interest to upsample.

3. The decoder of claim 2, wherein the parameters include an indicator of one of a plurality of region types and wherein the superresolution network applies upsampling specific to the indicated region type

4. The decoder of claim 1, wherein the superresolution processing and region unpacking module incudes a superrsolution network comprising a trained neural network.

5. The docoder of claim 4, wherein the superresolution network is trained on a dataset of images that have similar statistical properties to the pictures that are anticipated by a machine system processing the decoded bitstream.

6. The decoder of claim 5, wherein the superresolution network is trained to optimize object detection in the pictures anticipated by the machine system.

7. The decoder of claim 5, wherein the superresolution network is trained based on a loss function in a task network.

8. An encoder for video for machine consumption comprising:
a region detector module, the region detector module receiving the source video and identifying regions of interest therein, the regions of interest being defined in part by coordinates of a bounding box in the frame of source video;
a region transform module, the region transform module performing downsampling on at least one region of interest, wherein the downsampling is based in part on transform parameters from a machine system coupled to a decoder with a superresolution network for upsampling;
a region packing module, the region packing module receiving the set of regions of interest and transformed regions of interest and arranging the regions of interest into a packed frame in which pixels outside the regions of interest are substantially excluded; and
a video encoder receiving the packed frame and coordinates of the regions of interest and encoding the packed frame and region parameters into a coded bitstream.

9. The encoder of claim 8, wherein the region of interest comprise a plurality of object types and wherein the transform properties are specific to an object type.

10. The encoder of claim 8, wherein the transform properties are based at least in part on a superresolution network in a decoder which is trained by a task network to optimize a loss function.

11. The encoder of claim 10, wherein the superresolution network is trained on a dataset of images that have similar statistical properties to the pictures that are anticipated by a machine system.

12. The encoder of claim 8, wherein downsampling is determined on a region-by-region basis.

13. The encoder of claim 12, wherein downsampling is characterized by downsampling parameters applied by the region transform module for a region of interest and wherein the downsampling parameters are signaled in the coded bitstream.
